(19) United States
(12) Patent Application Publication
(10) Pub. No.: US 2006/0199411 A1
(43) Pub. Date: Sep. 7, 2006

(54) Windmill cable system and method

(76) Inventors: Brian Singh, New York, NY (US); Paul F. Savoca, E. Patochogue, NY (US)

Correspondence Address: NIXON PEABODY, LLP, 401 9TH STREET, NW, SUITE 900, WASHINGTON, DC, 20004-2128, US

(21) Appl. No.: 11/072,625

(22) Filed: Mar. 7, 2005

(51) Int. Cl. H01R 13/62

(52) U.S. Cl. 439/314

(57) ABSTRACT

An improved cable system and method for an electricity generating windmill having a base formed from a plurality of stacked base sections is provided. Each base section includes a bundle of both power and control cables which are alignable with one another when the base sections are stacked and assembled. Mating electrical connectors which may be easily interlocked are provided at the ends of the power and control cables, and in the terminals of the generator and inverter of the windmill. In the preferred embodiment, bayonet-type connectors are used to provide a secure, interlocking coupling between adjacent cable ends with a minimum amount of twisting motion between the cables, which are necessarily of heavy gauge to conduct the current produced by the generator. The system greatly facilitates installation of the cable system as well as repair or replacement of damaged or worn cables during the lifetime of the windmill.

### FIELD OF THE INVENTION

This invention generally relates to electrical cable systems, and is specifically concerned with an improved power cable system for an electricity generating windmill.

### BACKGROUND OF THE INVENTION

While windmills per se have been in existence for over one thousand years, electricity generating windmills capable of producing power on the order of several megawatts are a relatively recent development. The general structure of such a modern, power generating windmill is illustrated in FIGS. 1A and 1B. Such a windmill 1 generally comprises a support base 3 having a head assembly 5 oscillatingly mounted to the top end of the base 3. The head assembly 5 includes a DC generator 6 having a rotor 7 surrounded by a stator 8 and a power outlet terminal 9. A wind-operated blade assembly 10 is connected to the rotor 7 of the generator 6 via a gear train 11.

The support base 3 is formed from a plurality of stacked and joined base sections 12a-12d. An inverter circuit 14 is disposed in the interior of the support base 3 at the bottom thereof. The inverter circuit 14 includes an inlet terminal 16 for receiving the direct current produced by the generator 6, and a control power terminal 18 for distributing alternating current that has been converted from direct current produced from the generator 6 to various control systems (not shown) located in the head assembly 5 (i.e., an oscillating movement motor for moving the head assembly 5, a brake for governing the maximum speed of the blade assembly 10, and a mechanism for changing the pitch of the blades of the assembly 10).

In order to conduct the direct current produced by the generator 6 to the to the inverter circuit 14, it is necessary to provide a plurality of power cables between these two components. In the prior art, after the support base 3 had been assembled, fourteen 3.0 cm diameter power cables were hoisted up through the interior of the base, strapped together into a bundle, and secured to the inner walls of the base sections 12a-12d. These cables were hard-wired between the generator 6 and the inverter circuit 14. A section of these cables was allowed to hang between the generator 6 and the inner wall of the support base 3 in order to form a festoon or drip loop. The function of the drip loop was to absorb the tortional forces exerted on to the power cables when the head assembly oscillated relative to the support base 3 in response to changes in wind direction. These tortional forces are substantial, given the necessary 3.0 cm diameter of the power cables, which must carry 600 volts and 600 amps apiece, and the oscillatory range of the head assembly 5, which can rotate 540° in both the left and right directions. However, in view of the long length of the power cables necessary to span the 60-100 meter height of the support base 3 of such windmills, it proved prohibitively difficult and dangerous to the construction crew to hoist and mount such heavy cables into the configuration indicated in FIG. 1B.

Consequently, an alternative method of construction was developed. In this alternative method, fourteen cables having diameters on the order of 3.0 cm were cut into lengths corresponding to each length of the stacked sections forming the support base, and bundled together. One bundle of power cables was then mounted onto the inner walls of each base section 12a-12d along a common axis prior to the assembly of the support base 3. The insulation was removed at both ends of each of the power cable bundles prior to the stacking of the base sections 12a-12d. After the base sections 12a-12d were stacked and attached together to form the support base 3, adjacent ends of the axially aligned power cable bundles were spliced together by a workman operating a pneumatic splicing machine. An elastomeric sleeve was then heat shrunk or cold shrunk around each splice in order to prevent short circuiting between adjacent power cables.

While such a cable system was a vast improvement over the previous “hoist and mount” system, the applicant has observed a number of problems and shortcomings associated with it. First of all, the splicing operation has proven to be difficult and time consuming. It requires a skilled worker to be harnessed and pulled up into the appropriate locations and to operate a pneumatic splicing machine which squeezes aluminum cups around the bare, exposed ends of cables of adjacent power cable bundles. Such splicing machines weight on the order of 18 kilograms, and are difficult and time consuming to apply to a dense configuration of relatively stiff cable ends while suspended in midair. After the aluminum cups have been crimped and placed, insulating sleeves must be manually heat or cold shrunk over each new splice. The entire installation operation takes upwards of ninety hours to complete. Secondly, the resulting splices have proved to have an unacceptably high failure rate, despite the fact that the splicing machine squeezes the aluminum cups over the bare ends of adjacent cables at pressure of over 10,000 psi, and despite the diligence of skilled workers in applying insulating sleeves over the resulting splice. The constant tortional forces applied to the cable bundle connected directly to the generator, and thermal differential expansion and contraction due to ambient temperature changes, the constant vibration that the splices or subjected to due to ordinary operating conditions and to inclement weather, sometimes causes gaps to form in the spliced joints. Also, water can gradually accumulate in crevices formed by improperly applied insulating sleeves. The combination of such gaps and/or moisture has led to arcing severe enough to set fire to the insulation surrounding the cables. Finally, when such accidents have occurred, the hard-wired characteristics that such splices give to the power cable system have made it difficult and time consuming to replace sections of burned power cables.

Clearly, what is needed is a power cable system for an electricity generating windmill that is easier and faster to install, and which provides more reliable connections between the power cables than the crimp-type splices used in the prior art. Ideally, such a cable system would be better able to accommodate, at its upper section, the tortional forces constantly applied to it by reason of the oscillatory movement of the head assembly of the generator. It would also be desirable if such a system allowed damaged or worn cables to be removed and replaced easily and quickly without the need for large amounts of skilled labor.

### SUMMARY OF THE INVENTION

The invention is an improved cable system and method for an electricity generating windmill of a type having a base formed from a plurality of stacked base sections, wherein first and second base sections have first and second groups of power cables for conducting electricity generated by the windmill, and wherein ends of one group of power cables are adjacent to ends of another group of power cables or to a terminal of a generator or an inverter when the base sections are stacked and assembled. The improvement of the invention comprises mounting electrical connectors on the adjacent ends of different groups of power cables that detachably couple to one another to form either electrical connector assemblies between power cables, or between a bundle of power cables and the terminal of a generator or an inverter.

The electrical connectors forming the electrical connector assemblies may be detachably coupled by a mechanical interference coupling, such as a bayonet-type coupling that interlocks the connectors together when they are mated and twisted relative to one another. Preferably, when bayonet-type couplings are used, they are capable of interlocking when mated and twisted no more than 45° relative to one another to minimize the amount of tortional force necessary to interlock the power cables together. A ratchet lock is preferably provided in the bayonet-type coupling for preventing the coupling from being detached after the electrical connectors forming the assemblies are interlocked.

Whether the mechanical interference coupling takes the form of a bayonet-type coupling or not, it is preferably that the coupling allows done electrical connector to rotate at least 20° with respect to the connector it is coupled to in response to tortional forces applied to the cable. Such a feature advantageously allows the electrical connector assembly to accommodate, in a stress-reducing fashion, the tortional forces which are applied in particular to the upper portion of the power cables joining the generator to the first bundle of power cables located at the top of the base.

The power cables are preferably formed from a spirally-wound bundle of conductive wires, such as copper, covered by a flexible, elastomeric electrical insulator. To render the cables less more accommodating to the tortional forces which are applied to them during the oscillation of the head assembly of the windmill, the individual wires forming the conductive portion of the cable are all preferably helically wound in a same direction, i.e. either all left handed or all right handed. Such a structure enhances the ability of the cable to comply with torsional forces with reduced stress on the electrical connector assemblies.

Each of the electrical connector assemblies includes a water proof sleeve preferably formed from first and second mating sleeves circumscribing the two electrical connectors forming the assembly. These sleeves preferably detachably join in a water tight seal. To minimize the possibility of water incursion, each of the mating sleeves are preferably integrally formed on one end from the same insulation material circumscribing the helically wound wire conductors of the cable. The integrally formed end of each of the sleeves may include a stress relief portion for relieving bending stress on the wire conductors within the cable.

The cable system further includes first and second groups of control cables for supplying power to control systems of the electrical generator which are likewise formed into bundles and mounted along the inside walls of the base sections forming the support base of the windmill. Adjacent ends of the control cable bundles also preferably include electrical connectors that are detachably connectable to form electrical connector assemblies. Waterproof sealing structures are also included in these electrical connectors to prevent arcing and corrosion.

In the method of the invention, adjacent ends of bundles of power cables and control cables that have been previously mounted along the inside walls of the base sections of a windmill support base are provided with mateable electrical connectors prior to the stacking and joining of the base sections. After the base sections forming the support base have been stacked and assembled, the connectors of adjacent power and control cables are mated to form secure electrical connections between the cables. Additionally, the terminals of both the generator and the inverter circuit are likewise provided with connectors which mate with connectors provided on the ends of the power and control cables adjacent to these terminals.

The invention advantageously reduces the time of installation of the windmill cable system from ninety hours to approximately four hours. The resulting connections formed by the electrical connector assemblies are more secure, reliable, and accommodating of tortional forces applied to the upper ends of these cables as a result of the relative movement of the oscillating head assembly, and the support base. The use of a locking bayonet-type coupling between the electrical connectors provides good electrical contact, and a robust mechanical joint capable of easily withstanding the tensile force generated by the weight of the cables in the drip loop near the top of the support base. Additionally, a bayonet-type coupling requires very little movement along the axis of the cable in order for the mating connectors to be joined, which is particularly advantageous in an environment where the cables themselves are fixed to the support base and hence not axially moveable except at their free ends. Finally, the mating, water proof sleeves that are integrally formed at one end from the same insulation surrounding the cables greatly reduces the possibility of water incursion within the connections. This combination of features greatly reduces the probability of arcing, fire, and cable failure. In the event that one or more cables need to be replaced, the cable system of the invention greatly facilitates a replacement or repair operation.

### DESCRIPTION OF THE DRAWINGS

FIGS. 1A and 1B are a front and side cross-sectional view of an electricity generating windmill incorporating the cable system of the invention;

FIG. 2 is an enlargement of the circled portion of FIG. 1B, illustrating how the cable system of the invention electrically and mechanically couples the free ends of two adjacent power cable bundles;

FIGS. 3A and 3B are a side, cross-sectional view and a front view of one of the female connectors used to interconnect two power cables;

FIGS. 4A and 4B are a side, cross-sectional view and a front view of one of the male connectors used to interconnect two power cables, and

FIG. 5A is a side view of male and female connectors used to interconnect two adjacent control cable bundles, while FIGS. 5B and 5C are front views of the female and male connectors, respectively.

### DETAILED DESCRIPTION OF THE PREFERRED EMBODIMENT

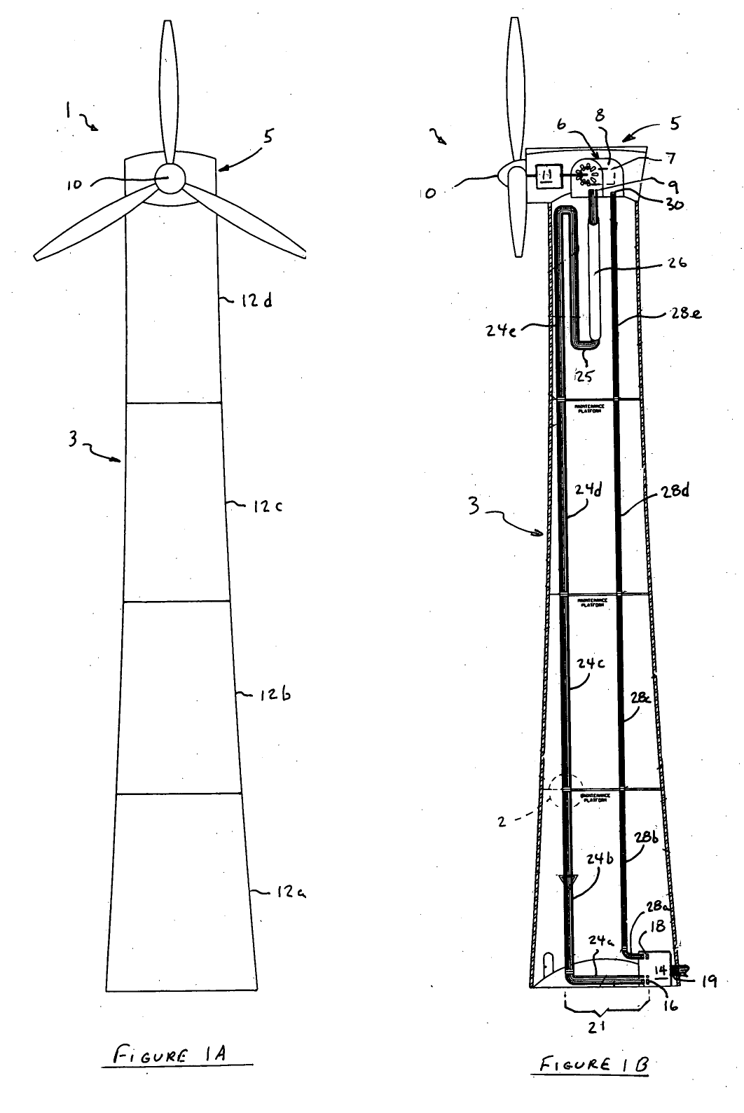

With reference now to FIGS. 1A and 1B, wherein like numerals designate like components throughout all the several figures, the electricity generating windmill 1 that the cable system of the invention is applicable generally to includes a support base 3 having a head assembly 5 oscillatorily mounted at the top thereof.

The head assembly 5 houses a DC generator 6 having a rotor 7 and stator 8, as well as power outlet terminal 9. The head assembly 5 further includes a blade assembly 10 driven by ambient wind. A gear train 11 couples the output shaft of the blade assembly 10 to the input shaft of the DC generator 6.

The support base 3 is formed from a plurality of stacked base sections 12a-12d. An inverter circuit 14 is disposed in the interior of the support base 3 at its bottom. The inverter circuit 14 includes an inlet terminal 16 for receiving direct current produced by the generator 6 and converting it into alternating current. The inverter circuit 14 further includes a control power outlet terminal 18 for powering the various control systems located in the head assembly 5 (i.e. oscillating motor control, blade pitch, cooling systems, and blade assembly braking system). Finally, inverter circuit 14 includes a power outlet terminal 19 for connecting the alternating current output of the windmill 1 to a power grid system.

The cable system 21 of the invention includes a plurality of cable bundles 24a-24e connected to the base sections 12a-12d of the support base 3 along a common longitudinal axis as is illustrated in FIG. 1B. While the power cable bundles 24a-24e are generally the same lengths as their respective support base sections 12a-12d, the first cable bundle 24a is relatively short, traversing only the distance between bundle 24b and inlet terminal 16 of the inverter circuit 14, while power cable bundle 24e is relatively longer than the rest, due to the doubling up of the power cables necessary to form the festoon or drip loop 25. A PVC sheath 26 surrounds part of the cable bundle 24 immediately under the DC generator 6 forming the drip loop 25 as shown. While the support base 3 of FIGS. 1A and 1B is shown as being formed from only four base sections 12a-12d, both the number and the height of these base sections may vary as the overall height of the support base 3 varies anywhere between 60 and 100 meters.

The cable system 21 of the invention further includes a plurality of control cable bundles 28a-28e arranged in the same mutually aligned configuration as the previously discussed power cable bundles 24a-24e. The overall function of the control cable bundles 28a-28e is to conduct power from the terminal 18 of the inverter circuit 14 to the power inlet terminal 30 located at the bottom of the head assembly 5 in order to power the various control systems of the head assembly 5. However, because the amount of power required for these control systems is far less than the power generated by the DC generator 6, the cables forming the control cable bundles 28a-28e are substantially smaller in diameter than the cables forming the power cable bundles 24a-24e.

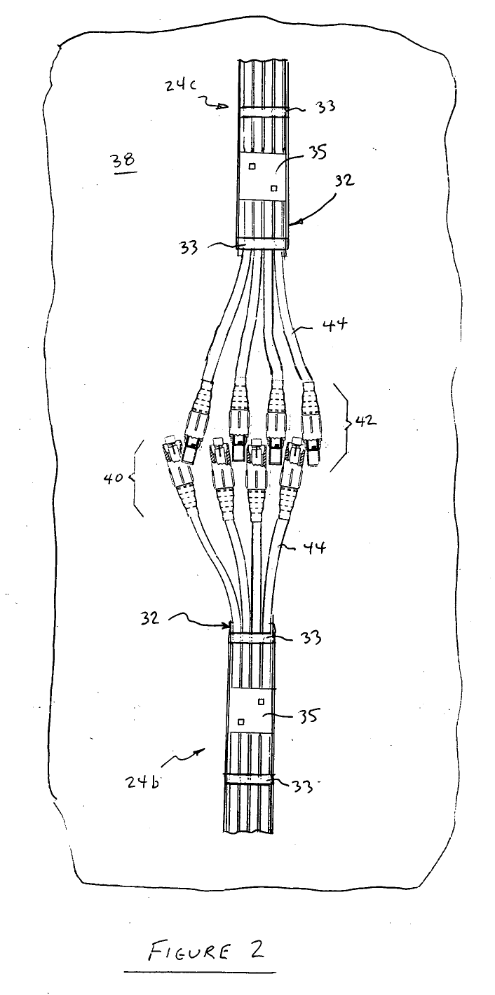

With reference now to FIG. 2, each of the power cable bundles 24a-24e is held together by the combination of a shallow, U-shaped tray 32 and cross brackets 33. The tray 32 receives, for example, three layers of four cables (of which only the outer layer is shown for simplicity). The brackets 33 retain the power cables in the tray by compression such that the weight of the power cables is born by the tray 32. The tray 32 is in turn secured via mounting plates 35 to the inner wall 38 of the support base 3. The free ends of the power cables forming the power cable bundles 24a-24e terminate in either male 40 or female 42 connectors. A sufficient amount of loose length 44 is provided between the male and female connectors 40, 42 and the last cross bracket 33 so as to allow the person assembling the cable system 21 a sufficient amount of play between adjacent cable ends to mate and twist the male and female connectors 40, 42 together into a connector assembly. For cables having a diameter of approximately 3 cm, the loose length 44 is approximately one-half meter. Such a length allows the workman assembling the cable system 21 to easily align, insert and twist each of the male and female connectors 45° with respect to one another in order to mechanically and electrically secure them together via bayonet-type coupling mechanism described hereinafter.

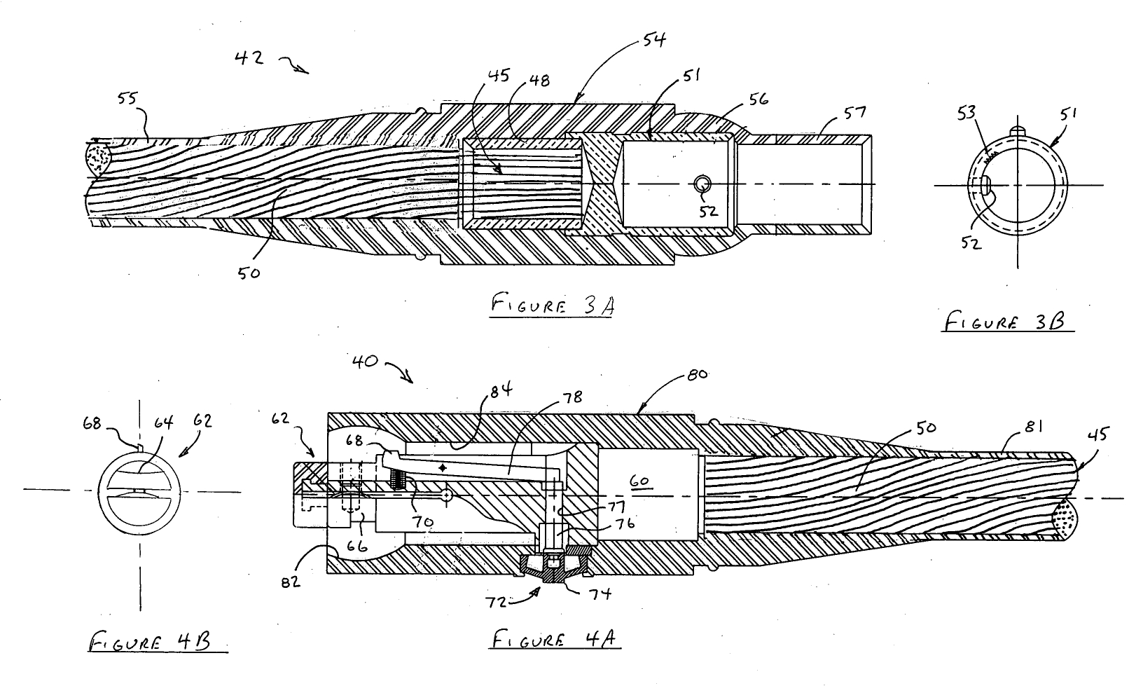

With reference now to FIGS. 3A and 3B, the female connectors 42 each include a crimp tube 48 at their back ends for receiving one end of the copper cable 45 within each of the power cables. Advantageously, the copper cable 45 is formed from a plurality of helically wound copper wires, all of which are twisted in the same direction (i.e., either a right hand or left hand helical twist). By contrast, copper cables of the prior art generally have overlapping layers alternately helically wound in right hand and left hand directions. While such alternate twisting of the wires may impart certain advantages to copper cables used in other contexts, the inventors have found that when all of the wires forming the copper cable 49 are helically twisted in either a left hand or right hand orientation, the resistance to tortional forces on the resulting power cables is substantially reduced, thereby lowering both the tortional resistance and stresses of the power cables forming the upper most cable bundle 24e which are periodically twisted in one direction or the other as the head assembly 5 oscillates relative to the support base 3.

A female barrel 51 is provided at the front end of the female connector 46. Barrel 51 includes a rounded cam member 52 that radially extends beyond the inner wall of the barrel 51 as shown. The inner wall of the barrel 51 further includes a plurality of ratchet teeth 53 which extend around the circumference of the barrel 51 for about 30°. The female connector 42 is surrounded by a waterproof sleeve 54 that is integrally formed with the cable insulation 55. The sleeve 54 includes a hemispherical projection 56 that surrounds the outer end of the barrel 51, and a tubular protrusion 57 which extends from the front of the hemispherical projection 56.

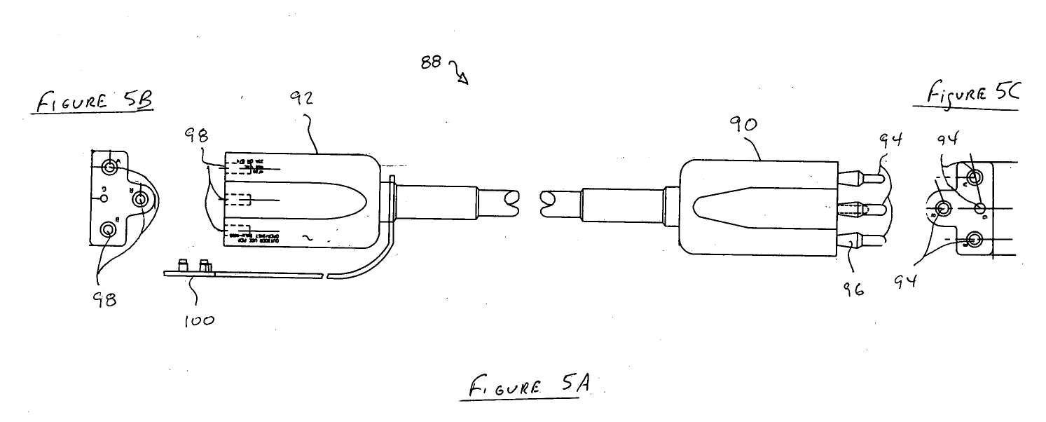

With reference now to FIGS. 4A and 4B, the male connector 40 likewise includes a crimp tube 60 at its back end for receiving the ends of a copper cable 49 formed from copper wires 50 which are helically wound in a same direction. At its front end, the male connector 40 includes a split male pin 62 which is generally complementary in shape to the inner walls of the barrel 51 of the female connector 42. The split male pin 62 includes a flattened side 64 for receiving the rounded cam member 52 of the female barrel 51. A cam groove 66 is provided at the back of the split male pin that accommodates the cam member 62 to create the bayonet locking action when the male pin 62 is inserted into the female barrel 51 and twisted. A ratchet pawl 68 is biased into an engaging position via spring 70 with the previously discussed ratchet teeth 53 on the inner walls of the female barrel 51. The engagement between the ratchet pawl 68 and the ratchet teeth 53 when the male and female connectors 40 and 42 are mated and twisted prevents the connectors from mechanical disengagement during the operation of the cable system 21. For disengagement of the male and female connectors 40 and 42, a pawl retractor 72 is provided. Pawl retractor 72 includes a detent button 74 formed from an elastomeric material which in turn contacts a plunger 76 which is reciprocally movable within a bore 77. The distal end of the plunger 68 engages a pawl lever 78 which, when depressed, withdraws the ratchet pawl 68 back into a groove in the split male pin, thereby disengaging it from the ratchet teeth 53 of the female barrel 51. It should be noted that the cam groove 66 extends around the circumference of the back of the split male pin 62 a substantially greater extent than the ratchet teeth on the inner wall of the female barrel 51 (i.e., 120° vs. 30°). Such relative dimensioning allows the split male pin 62 to rotate within the female barrel 51 up to approximately 20° in response to torsional forces applied to the power cables after the ratchet pawl 68 is rotated past al of the ratchet teeth 53.

Like the previously described female connector 42, the male connector 40 likewise includes a waterproof sleeve 80 which is likewise integrally formed with the insulation 81 covering the copper cable 49. The waterproof sleeve 80 also includes a hemispherical recess 80 which is complementary in shape to the hemispherical projection 56 of the waterproof sleeve 54 of the female connector 42. This hemispherical recess 82 terminates with a cylindrical recess 84 surrounding the rear of the split male pin 62 which is complementary in shape to the tubular protrusion 57 of the female waterproof sleeve 54. Both waterproof sleeves 54 and 80 and cable insulations 55 and 81 are preferably formed from a flexible, compliant artificial rubber such as Hypalon.

It should be noted that the basic design features of the male and female connectors 40, 42 do not per se form the invention, being previously disclosed in U.S. Pat. Nos. 3,109,690; 3,226,667 and RE 25,506, the entire specifications of which are hereby expressly incorporated by reference.

With reference now to FIGS. 5A, 5B and 5C, the control cable bundles 28a-28e are formed from a plurality of control cables 88 terminating in male and female connectors 90, 92 as shown. Because the load applied to such control cables is far smaller than the load applied to the power cables (i.e., 30 amps vs. 600 amps), the diameter of the control cables 89 is substantially smaller than the diameter of the previously discussed power cables. Accordingly, the weight of the control cables 88 is far less, and so there is no need for the male and female connectors 90, 92 to employ the bayonet-type coupling used in conjunction with the power cables. Instead, the male connector 90 includes a plurality of male prongs 94a, 94b, 94c and 94d, three of which are surrounded by a conically shaped waterproofing sleeve 96. These sleeves 96 are insertable into cylindrical recesses 98 in the female connectors 92. The metallic ends of the male prongs 94a-94d are, of course, receivable within contacting barrels (not shown) in the female connector 92. Preferably, the female connector 92 is provided with a receptacle cap 100 which can be snapped over the cylindrical recesses 98 in order to prevent water from entering the metallic barrels within the female connector 92. Although not specifically shown in the drawings, the control cable bundles 28a-28e are constructed much the same as the previously described power cable bundles 24a-24e, and are secured onto the inner wall 38 of the support base 3 by way of a tray and bracket structure so that the weight of the bundles 28a-28e is supported along the wall 38. Typically, each bundle 28a-28e has only four cables.

In operation, the individual cables forming both the power cable bundles 24a-24e and control cable bundles 28a-28e are manufactured with appropriate male or female connectors on either end. Each cable bundle whether 24a-24e or 28a-28e is then mounted within its respective base section 12a-12d via the previously described tray 32, brackets 33 and mounting plates 35. Each of the power cable bundles 24a-24e and control cable bundles 28a-28e is mounted along a same longitudinal axis in the base sections 12a-12d such that when the base sections 12a-12d are stacked and assembled to one another, the bundles 24a-24e and 28a-28e are aligned with one another. The male and female connectors of adjacent cable ends are then secured together to form electrical connector assemblies by mating and twisting with respect to the power cable bundles 24a-24e, and merely by mating in the case of the control cable bundles 28a-28e. The electrical connectors of both the power cable bundles 24a-24e and control cable bundles 28a-28e adjacent to the terminals of the generator 6 and inverter circuit 16 are likewise mated to complimentary-shaped electrical connectors located in these terminals. The cable system is then ready for use. In the event that one or more of the cables within the power cable bundles 24a-24e or control cable bundles 28a-28e needs to be repaired or replaced, the male and female connectors located on either end of such cables may easily be detached from its mating electrical connector so that the damaged or defective cable may be removed.

While this invention has been described with respect to a preferred embodiment, various modifications, additions and substitutions may be made without departing from the scope of the invention. For example, while the invention has been described with respect to a wind powered DC generator that utilizes fourteen power cables, it can also apply to wind powered AC generators that utilize any where between 3 and 14 power cables. While a bayonet-type mechanism has been described with respect to the connectors joining the power cable bundles 24a-24e, other types of mechanically interlocking connectors may also be used. While waterproof sleeves are preferred which are integrally molded into the insulation of the cable, any type of sleeve which is merely vulcanized into the insulation, or otherwise sealingly connected to it may also be used. Additionally, a number of different support structures other than the previously described trays and brackets may be used to support the power cable bundles 24a-24e and control cable bundles 28a-28e. Also, it is possible for a cable bundle to traverse the length of two base sections in the event that such sections are unusually short. All such modifications, variations and additions are encompassed within the scope of the invention, which is limited only by the claims appended hereto and their equivalents.

What is claimed is:

1. An improved cable system for an electricity generating windmill of a type having a base formed from a plurality of stacked base sections, wherein first and second base sections have first and second groups of power cables for conducting electricity generated by the windmill, and wherein ends of one group of power cables are adjacent to ends of another group of power cables or to a terminal of an electric device when said base sections are stacked, wherein the improvement comprises:
electrical connectors mounted on said ends of said one group of power cables that detachably couple to electrical connectors mounted on said adjacent ends of said another group of power cables or to electrical connectors mounted in said terminal of said electric device to form electrical connector assemblies between said groups of power cables or a group of power cables and said terminal.

2. The system according to claim 1, wherein at least some of said electrical connectors forming said electrical connector assemblies are detachably coupled by a mechanical interference coupling.

3. The system according to claim 2, wherein said electrical connectors forming said electrical connector assemblies are detachably coupled by a bayonet-type coupling that interlocks said electrical connectors together when they are mated and twisted relative to one another.

4. The system according to claim 3, wherein said bayonet-type coupling includes a ratchet lock that prevents bayonet-type coupling from becoming detached after said electrical connectors forming said assembly are mated and twisted.

5. The system according to claim 3, wherein said bayonet-type coupling interlocks said electrical connectors when said connectors are mated and each twisted no more than 45° with respect to each other.

6. The system according to claim 2, wherein said mechanical interference coupling allows one electrical connector to rotate at least 15° with respect to another in response to torsional forces after said electrical connectors have been detachably coupled into electrical connector assemblies.

7. The system according to claim 1, wherein said electrical connector assemblies include a waterproof sleeve.

8. The system according to claim 7, wherein said waterproof sleeve includes first and second mating sleeves circumscribing first and second connectors respectively, that detachably join in a water tight seal.

9. The system according to claim 8, wherein said mating sleeves are integrally formed from a same insulation material on an outside of said power cables.

10. The system according to claim 1, wherein said power cables include a plurality of single strand metallic conductors, substantially all of which are helically wound in a same direction to provide torsional flexibility to the cable.

11. An improved cable system for an electricity generating windmill of a type having a base formed from a plurality of stacked base sections, wherein first and second base sections have first and second groups of power cables for conducting electricity generated by the windmill, and wherein ends of one group of power cables are adjacent to ends of another group of power cables or to a terminal of an electric device when said base sections are stacked, wherein the improvement comprises:
electrical connectors mounted on said ends of said one group of power cables that detachably couple to electrical connectors mounted on said adjacent ends of said another group of power cables or to electrical connectors mounted in said terminal of an electric device to form electrical connector assemblies between said groups of power cables or a group of power cables and said terminal,
wherein said connectors include a conductive metal member, and at least some of said electrical connectors forming said electrical connector assemblies are detachably coupled by a mechanical interference coupling formed by interlocking portions of their conductive metal members.

12. The system according to claim 11, wherein said electrical connectors forming said electrical connector assemblies are detachably coupled by a bayonet-type coupling that interlocks said electrical connectors together when they are mated and twisted relative to one another.

13. The system according to claim 12, wherein said bayonet-type coupling includes a ratchet lock that prevents bayonet-type coupling from becoming detached after said electrical connectors forming said assembly are mated and twisted.

14. The system according to claim 12, wherein said bayonet-type coupling interlocks said electrical connectors when said connectors are mated and each twisted no more than 45° with respect to each other.

15. The system according to claim 11, wherein said mechanical interference coupling allows one electrical connector to rotate at least 20° with respect to another in response to torsional forces after said electrical connectors have been detachably coupled into electrical connector assemblies.

16. The system according to claim 11, wherein said cables include a plurality of single strand metallic conductors, substantially all of which are helically wound in a same direction to provide torsional flexibility to the cable.

17. The system according to claim 11, wherein said electrical connector assemblies include a waterproof sleeve.

18. The system according to claim 17, wherein said waterproof sleeve includes first and second mating sleeves circumscribing first and second connectors respectively, that detachably join in a water tight seal.

19. The system according to claim 18, wherein said mating sleeves are integrally formed from a same insulation material on an outside of said cables.

20. The system according to claim 11, wherein said electrical device is one of an electrical generator and an inverter circuit.

21. The system according to claim 17, wherein said sleeve includes a stress relief portion.

22. The system according to claim 11, further comprising first and second groups of control cables for supplying power to control systems of said electrical generator, wherein first and second control cable groups are mounted on said first and second base sections and have ends that are adjacent one another and which include electrical connectors that are detachably connectable.

23. The system according to claim 11, wherein said windmill has a head assembly that includes said generator and is oscillatingly mounted on a top end of said base.

24. The system according to claim 23, wherein said groups of power cables includes a loop of said cables between said generator and a group of cables mounted on a top base section to accommodate oscillatory movement of the generator relative to the base.

25. An improved method for installing a system of cables in an electricity generating windmill that conduct electricity generated by the windmill to an inverter circuit, wherein said windmill is of a type having a base formed from a plurality of stacked base sections, wherein first and second base sections have first and second groups of power cables for conducting electricity generated by the windmill, and wherein ends of one group of power cables are adjacent to ends of another group of cable or to a terminal of an electric device when said base sections are stacked, comprising the steps of
mounting electrical connectors on said ends of said groups of power cables and on said terminal that detachably couple to form electrical connector assemblies between said groups of power cables or a group of power cables and said terminal, and
detachably connecting said connectors together after said base sections are stacked.

26. The method according to claim 25, wherein said electrical connectors are mounted on said ends of said groups of cables prior to stacking said base sections together.

27. The method according to claim 26, wherein the electrical connectors on said group of cables are detachably coupled after said base sections are stacked together.

28. The method according to claim 25, wherein said electrical connectors are detachably connected by a bayonet-type coupling between the connectors.
